(19) United States
(12) Patent Application Publication
(10) Pub. No.: US 2021/0098752 A1
(43) Pub. Date: Apr. 1, 2021

(54) COMPOSITE PACKAGING MATERIAL FOR LITHIUM BATTERY

(71) Applicant: BenQ Materials Corporation, Taoyuan City (TW)

(72) Inventor: Yu-Ting CHIU, Taoyuan City (TW)

(21) Appl. No.: 16/866,569

(22) Filed: May 5, 2020

(30) Foreign Application Priority Data
Sep. 27, 2019 (TW) 108135303
Mar. 26, 2020 (TW) 109110335

(51) Int. Cl. H01M 2/02; B32B 15/20; B32B 7/12; B32B 27/28; B32B 15/085; B32B 27/32; H01M 10/052; C09J 175/06; C09J 123/14

(52) U.S. Cl. CPC H01M 2/029; B32B 15/20; B32B 7/12; B32B 27/281; B32B 15/085; H01M 2220/30; H01M 10/052; H01M 2/026; C09J 175/06; C09J 123/14; B32B 2457/10; B32B 27/32

(57) ABSTRACT

The present disclosure relates to a composite packaging material for a lithium battery. The composite packaging material for a lithium battery sequentially comprises a protective layer, a polyurethane adhesive layer, an aluminum foil layer, a polyolefin adhesive layer and a heat seal layer. Wherein, a damping factor (tan δ) of the polyurethane adhesive layer is in the range of 0.45 and 0.6. The polyurethane adhesive layer has suitable damping property such that the stress applied to the composite packaging material by the deep drawing equipment can be buffered and dissipated, so that the formability of the composite packaging material can be enhanced and the damage of the composite packaging material can be reduced during a deep drawing process.

### CROSS-REFERENCE TO RELATED APPLICATIONS

This application claims the priority benefit of Taiwanese Application Serial Number 108135303, filed Sep. 27, 2019, and 109110335, filed Mar. 26, 2020, which are incorporated herein by reference.

### TECHNICAL FIELD

The invention relates to a composite packaging material, and more particularly to a composite packaging material for a lithium battery.

### BACKGROUND OF THE INVENTION

Secondary lithium batteries are developing towards high volume energy density, and are widely used in portable electronic devices, such as smart phones and the like. In recent years, with the miniaturization and weight reduction of mobile devices, the outer packaging materials of lithium secondary batteries are also required to be thin and light, and can be applied to different battery sizes. Therefore, traditional metal can has been replaced by a composite packaging material having a thickness of 10 to 100 micrometers (μm) to produce a so-called pouch cell lithium battery in order to cut down the weight of the battery.

As a composite packaging material for a lithium battery, an aluminum laminated film is generally obtained by laminating a protective layer, an aluminum foil layer, and a heat seal layer with adhesives. Each layer in the composite packaging material needs to have specific physical and chemical properties. The protective outermost layer must have good puncture resistance, abrasion resistance, and impact resistance to protect the internal film layer from scratches and to reduce the shock of the battery caused by dropping. The aluminum foil layer must have good plasticity and gas barrier properties to provide plasticity during deep drawing and prevent ambient gases such as water vapor and oxygen from penetrating into the battery. The heat seal layer must have good heat-sealability and electrolyte resistance, so that the battery does not leak electrolyte during long-term use and storage, and does not react chemically with the electrolyte.

During the production of pouch cell lithium batteries, the composite packaging material is conducted to deep draw, due to the different ductility of the protective layer and the aluminum foil layer. The ductility and the tensile strength of the protective layer is insufficient to buffer the stress applied by deep drawing so as to cause the damage to the protective layer and the aluminum foil layer. Therefore, the formability of the composite packaging material is limited.

In the state of the art, the mechanical properties of the composite packaging material are generally adjusted by changing the thickness of each layer therein to reduce stress damage to the composite packaging material and enhance the formability thereof. However, for maintaining the required properties of a battery packing film, the change of the thickness of each layer in the composite packing film is limited.

Therefore, there is still a need for a composite packaging material for a lithium battery that can enhance the forming depth.

### SUMMARY OF THE INVENTION

In view of the foregoing problems, the present invention is to provide a composite packaging material for a lithium battery, which sequentially includes a protective layer, a polyurethane adhesive layer, an aluminum foil layer, a polyolefin adhesive layer, and a heat seal layer, wherein a damping factor (tan δ) of the polyurethane adhesive layer is between 0.45 and 0.6. In the composite packaging material of the present invention, the aforementioned polyurethane adhesive layer can provide good interlayer adhesion and forming ductility to cushion and dissipate stress during deep drawing, avoiding damage to the material caused by the stress concentration and thereby enhancing the formable depth of the composite packaging material.

In an embodiment of the present invention, the adhesive polyurethane layer comprises a polyurethane adhesive and a multifunctional hindered phenol, wherein the amount of the multifunctional hindered phenol is from 4 to 10 parts by weight relative to per hundred parts by weight of polyurethane adhesive.

In an embodiment of the present invention, the multifunctional hindered phenol comprises at least one of trifunctional hindered phenol or tetrafunctional hindered phenol.

In an embodiment of the present invention, the multifunctional hindered phenol is at least one selected from the group consisting of 1,3,5-tris(3,5-di-tert-butyl-4-hydroxybenzyl)-1,3,5-triazinane-2,4,6-trione, 1,3,5-trimethyl-2,4,6-tri-(3,5-di-tert-butyl-4-hydroxybenzyl)benzene, pentaerythritol tetrakis [methylene-3-(3′,5′-di-tert-butyl-4′-hydroxyphenyl)propionate]methane, and the combination thereof.

In an embodiment of the present invention, the polyurethane adhesive comprises 85.7 to 90.9 parts by weight of polyester polyol and 10.1 to 14.3 parts by weight of polyisocyanate.

In an embodiment of the present invention, the thickness of the adhesive polyurethane layer is in the range between 2 μm and 10 μm.

Another aspect of the present invention is to provide a composite packaging material for a lithium battery, which sequentially comprises a protective layer, a polyurethane adhesive layer, an aluminum foil layer, a polyolefin adhesive layer, and a heat seal layer, wherein the adhesive polyurethane layer comprises a polyurethane adhesive and a multifunctional hindered phenol, wherein the amount of multifunctional hindered phenol is from 4 to 10 parts by weight relative to per hundred parts by weight of polyurethane adhesive.

In another embodiment of the present invention, the multifunctional hindered phenol comprises at least one of trifunctional hindered phenol or tetrafunctional hindered phenol.

In another embodiment of the present invention, the multifunctional hindered phenol is at least one selected from the group consisting of 1,3,5-tris(3,5-di-tert-butyl-4-hydroxybenzyl)-1,3,5-triazinane-2,4,6-trione, 1,3,5-trimethyl-2,4,6-tri-(3-di-tert-butyl-4-hydroxybenzyl)benzene, pentaerythritol tetrakis(3-(3,5-di-tert-butyl-4-hydroxyphenyl)propionate), and the combination thereof.

In another embodiment of the present invention, the polyurethane adhesive comprises 85.7 to 90.9 parts by weight of polyester polyol and 10.1 to 14.3 parts by weight of polyisocyanate.

In another embodiment of the present invention, a glass transition temperature (T_{g}) of the polyester polyol is in the range between −10° C. to 30° C.

In another embodiment of the present invention, the polyester polyol is obtained by polymerizing a polyacid containing carboxyl group (COOH) and a polyol containing hydroxyl group (OH), and the number average molecular weight of the polyester polyol is between 8,000 and 30,000.

In another embodiment of the present invention, the polyisocyanate is at least one selected from the group consisting of trimethylene diisocyanate, tetramethylene diisocyanate, hexamethylene diisocyanate, 1,2-propylene diisocyanate, 1,2-butene diisocyanate, 2,3-butene diisocyanate, 1,3-butene diisocyanate, 2,4,4-trimethylhexamethylene diisocyanate, 2,2,4-trimethylhexamethylene diisocyanate, 2,6-diisocyanate methylhexanoate diisocyanate, 1,4-cyclohexane diisocyanate, 1,3-cyclohexane diisocyanate, m-phenylene diisocyanate, p-phenylene diisocyanate, 4,4′-diphenyl diisocyanate, 1,5-naphthalene diisocyanate, 4,4′-diphenylmethane diisocyanate, 2,4-toluene diisocyanate, 2,6-toluene diisocyanate, 4,4′-toluidine diisocyanate, 3,3′-dimethoxybenzidine diisocyanate, 4,4′-diphenyl ether diisocyanate, 1,3-xylene diisocyanate, 1,4-xylene diisocyanate, ω, w′-diisocyanate-1,4-diethylbenzene, 1,3-bis(1-isocyanato-1-methylethyl)benzene, 1,4-bis(1-isocyanato-1-methylethyl)benzene, triphenylmethane-4,4′,4″-triisocyanate, benzene-1,3,5-triisocyanate, toluene-2,4,6-triisocyanate, 4,4′-diphenyldimethylmethane-2,2′,5,5′-tetraisocyanate, and dimer, trimer, biuret and urethanate derived from the above isocyanate monomer, the polyisocyanate containing 2,4,6-oxadiazine trione ring derived from carbon dioxide and the above isocyanate monomer, and the combination thereof.

In another embodiment of the present invention, the damping factor of the adhesive polyurethane layer is in the range between 0.45 and 0.6.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### BRIEF DESCRIPTION OF THE DRAWINGS

The invention can be more fully understood by reading the following detailed description of the embodiment, with reference made to the accompanying drawings as follows.

FIG. 1 is a composite packaging material for lithium battery according to an embodiment of the present invention of the present invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The term “damping factor” used herein refers to the ratio of the loss modulus of the viscoelastic material to the storage modulus thereof. “Damping effect” refers to the ability of an object to absorb mechanical energy and dissipate it when it undergoes elastic deformation due to an impact.

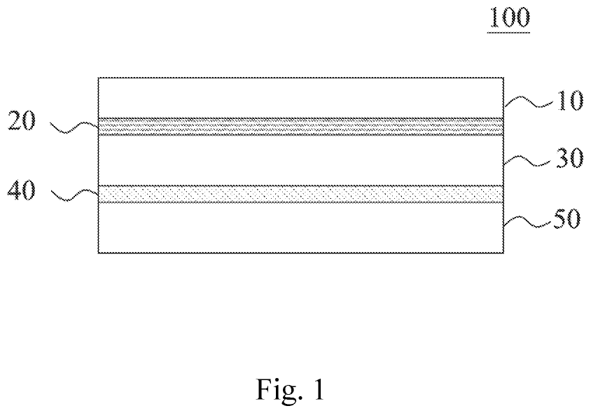

The composite packaging material for a lithium battery according to the present invention is explained below through the drawings. As shown in FIG. 1, a composite packaging material 100 for a lithium battery of the present invention sequentially comprises a protective layer 10, a polyurethane adhesive layer 20, an aluminum foil layer 30, a polyolefin adhesive layer 40, and a heat seal layer 50. The heat seal layer is used as an inner layer of a battery package, and it forms a concave area during a deep drawing process for containing the components of a battery such as electrolyte. The protective layer is used as an outer layer, and it forms a convex area during a deep drawing process and exposes to the external environment.

The protective layer 10 of the composite packaging material for a lithium battery of the present invention can be, for example, a polyamide film, and is preferably a biaxially stretched polyamide film. The use of a polyamide film as the protective layer 10 can provide excellent softness, abrasion resistance, puncture resistance, heat resistance, and insulation properties. The polyamide film can prevent the inner layer of the composite packaging material 100 from being scratched, and can buffer the external impact on the components of a battery. Preferably, the thickness of the protective layer 10 is in the range between 15 and 40 micrometers (μm) to provide a sufficient protection effect.

The polyurethane adhesive layer 20 is used to adhere to a protective layer 10 and an aluminum foil layer 30. In one embodiment of the present invention, the damping factor (tan δ) of the polyurethane adhesive layer 20 is in the range between 0.45 and 0.6. The polyurethane adhesive layer 20 with damping factor within this range can adhere to the protective layer 10 and the aluminum foil layer 30 well, and provide a damping effect for buffering and dissipating stress induced by the punch impact during the deep drawing to the composite packing film, so as to avoid damage to the protective layer 10 and the aluminum foil layer 30 during deep drawing, thereby enhancing the formability of the composite packaging material 100.

In one embodiment of the present invention, the adhesive polyurethane layer 20 comprises a polyurethane adhesive and a multifunctional hindered phenol. Because the phenolic hydroxyl group in the multifunctional hindered phenol can hydrogen-bond to nitrogen and oxygen atoms in the polyurethane adhesive, the breaking of the hydrogen bonds thereof can convert the mechanical energy induced by the punch into thermal energy dissipation during the deep drawing.

In one embodiment of the present invention, the use amount of the multifunctional hindered phenol is from 4 to 10 parts by weight relative to per hundred parts by weight of polyurethane adhesive. When the use amount of the multifunctional hindered phenol is less than 4 parts by weight, the damping effect is limited. When the use amount of the multifunctional hindered phenol is more than 10 parts by weight, the excess amount of the multifunctional hindered phenol will cause a steric effect between the molecular chains of polyurethane, and further hinder the generation of hydrogen bonds and reduce the damping effect.

Suitable multifunctional hindered phenols can have a relatively high molecular weight and exhibit non-volatile characteristics at high temperatures. Preferably, the suitable multifunctional hindered phenol can be trifunctional hindered phenol with 1,3,5-triazine or 1,3,5-trimethylbenzene as a skeleton, or tetrafunctional hindered phenol with neopentyl tetraol as a skeleton. The suitable trifunctional hindered phenol can be, such as but not limited to 1,3,5-tris(3,5-di-tertiary-butyl-4-hydroxybenzyl)-1,3,5-triazine-2,4,6-trione (MW: 784.08) or 1,3,5-trimethyl-2,4,6-tri (3,5-di-tert-butyl-4hydroxybenzyl)benzene (MW: 775.20). The suitable tetrafunctional phenol hindered phenol can be, such as but not limited to pentaerythritol tetrakis(3-(3,5-di-tert-butyl-4-hydroxyphenyl)propionate) (MW: 1177.63). The suitable multifunctional hindered phenols can be one of the multifunctional hindered phenols mentioned above or the combination thereof, but not limited thereto.

Since the damping factor is related to the thickness of the adhesive layer, the thickness of the polyurethane adhesive layer 20 can be between 2 and 10 μm in order to maintain a suitable damping factor, and preferably between 2 and 7 μm. When the thickness of the polyurethane adhesive layer 20 is less than 2 μm, not only the insufficient adhesion of the adhesive layer is caused, but also the damping effect is not sufficient when the composite packing film is deep drawn. When the thickness of the polyurethane adhesive layer 20 is greater than 10 μm, the adhesive strength of the adhesive layer may be reduced.

In an embodiment of the present invention, the polyurethane adhesive comprises 85.7 to 90.9 parts by weight of polyester polyol and 10.1 to 14.3 parts by weight of polyisocyanate. When the use amount of polyester polyol is too low, the relatively excess amount of the polyisocyanate will have side reactions other than the polymerization of polyester polyol, which will reduce the ductility and adhesion of the polyurethane adhesive. When the use amount of the polyester polyol is too high, the polymerization of polyester polyol and polyiscocyanate may be incomplete and cause the reduction of the adhesive strength of the polyurethane adhesive.

Suitable glass transition temperature (T_{g}) of the polyester polyol is in the range between −10° C. to 30° C. When the glass transition temperature (T_{g}) of the polyester is lower than −10° C., the formability of the polyurethane adhesive layer 20 may be affected. When the glass transition temperature (T_{g}) of the polyester is higher than 30° C., the adhesive strength of the polyurethane adhesive layer 20 may be affected.

In an embodiment of the present invention, the number average molecular weight of the polyester polyol is between 8,000 and 30,000, and preferably between 10,000 and 20,000. When the number average molecular weight of the polyester polyol is less than 8,000, the cohesion of the polyurethane adhesive layer may be insufficient and cause peeling, such as the interlayer sliding and bulging, between the two adhered substrates of the laminated composite packaging material. When the number average molecular weight of the polyester polyol is more than 30,000, the decreased solubility and increased viscosity of the polyester polyol may cause the prepared adhesive solution with insufficient fluidity and poor wettability to the substrate.

Suitable polyester polyol can be obtained by polymerizing a polyacid containing carboxyl group (—COOH) and a polyol containing hydroxyl group (—OH). The suitable polyacid can be selected from, such as but not limited to isophthalic acid, terephthalic acid, naphthalic acid, phthalic acid, adipic acid, azelaic acid, sebacic acid, succinic acid, glutaric acid, trimellitic acid, pyromellitic acid, phthalic acid, dicarboxylic anhydride, tetrahydrophthalic anhydride, hexahydrophthalic anhydride, maleic anhydride, itaconic anhydride, and the combination thereof. The suitable polyol can be selected from, such as but not limited to ethylene glycol, diethylene glycol, triethylene glycol, propylene glycol, dipropylene glycol, 1,6-hexanediol, neopentyl glycol, 1,4-butanediol, 1,4-cyclohexanedimethanol, Trimethylolpropane, glycerol, 1,9-nonanediol, 3-methyl-1,5-pentanediol, polyether polyol, polycarbonate polyol, polyolefin polyol, acrylic polyol, polyurethane polyol, and the combination thereof.

Suitable polyisocyanate can be selected from, including but not limited to aliphatic diisocyanate such as trimethylene diisocyanate, tetramethylene diisocyanate, hexamethylene diisocyanate, 1,2-propylene diisocyanate, 1,2-butene diisocyanate, 2,3-butene diisocyanate, 1,3-butene diisocyanate, 2,4,4-trimethylhexamethylene diisocyanate, 2,2,4-trimethylhexamethylene diisocyanate and 2,6-diisocyanate methylhexanoate diisocyanate, and cyloaliphatic diisocyanate such as 1,4-cyclohexane diisocyanate and 1,3-cyclohexane diisocyanate, and aromatic diisocyanate such as m-phenylene diisocyanate, p-phenylene diisocyanate, 4,4′-diphenyl diisocyanate, 1,5-naphthalene diisocyanate, 4,4′-diphenylmethane diisocyanate, 2,4-toluene diisocyanate, 2,6-toluene diisocyanate and the combination thereof, 4,4′-toluidine diisocyanate, 3,3′-dimethoxybenzidine diisocyanate and 4,4′-diphenyl ether diisocyanate, and aromatic aliphatic diisocyanate such as 1,3-xylene diisocyanate, 1,4-xylene diisocyanate and the combination thereof, ω,ω′-diisocyanate-1,4-diethylbenzene, 1,3-bis(1-isocyanato-1-methylethyl)benzene, 1,4-bis(1-isocyanato-1-methylethyl)benzene and the combination thereof, and organic triisocyanate such as triphenylmethane-4,4′,4″-triisocyanate, benzene-1,3,5-triisocyanate and toluene-2,4,6-triisocyanate, and organic tetraisocyanate such as 4,4′-diphenyldimethylmethane-2,2′,5,5′-tetraisocyanate, and can also be dimer, trimer, biuret and urethanate derived from the above isocyanate monomer, the polyisocyanate containing 2,4,6-oxadiazine trione ring derived from carbon dioxide and the above isocyanate monomer, and the combination thereof.

Suitable polyisocyanate can also be the polyisocyanate modified by polyol. The suitable polyol can be selected from, including but not limited to the adduct of polyols with molecular weights less than 200, such as ethylene glycol, propylene glycol, butanediol, hexanediol, neopentyl glycol, 1,6-hexanediol, 3-methyl-1,5-pentanediol, 3,3′-dimethylolpropane, cyclohexanedimethanol, diethylene glycol, triethylene glycol, dipropylene glycol, glycerin, trimethylolpropane, neopentyl alcohol and sorbitol, and the adduct of polyester polyol, polyetherester polyol, polyesteramine polyol, polycaprolactone polyol, polyvalerolactone polyol, acrylic polyol, polycarbonate polyol, polyhydroxyalkanes, castor oil and polyurethane polyols with molecular weights between 200 and 20,000.

The protective layer 10 and the aluminum foil layer 30 are laminated by the polyurethane adhesive layer 20. First in this process, the polyester polyol, the polyisocyanate, and the multifunctional hindered phenol are mixed to obtain an adhesive solution and the adhesive solution is coated on the surface of the aluminum foil layer 30. After that, the protective layer 10 is laminated to the aluminum foil layer 30 and then perform a curing process. During the curing process, the polyurethane is polymerized from hydroxyl group (—OH) of the polyester polyol and isocyanate group (—NCO) of the polyisocyanate, thereby forming an adhesive polyurethane layer. Wherein, the multifunctional hindered phenol does not participate in the polymerization, but is doped between the molecular chains of polyurethane, and it generates hydrogen bonds with polyurethane, which can produce a damping effect.

In addition, appropriate amounts of additives can also be added to the polyurethane adhesive to adjust reactivity, operability or other required properties of the adhesive according to actual needs. These additives are optionally used by those skilled in the art without particular limited.

The aluminum foil layer 30 of the composite packaging material for a lithium battery of the present invention can be a soft aluminum foil made of pure aluminum or an aluminum foil containing 2 wt % iron for sufficient ductility and gas barrier properties of the composite packaging material. Preferably, the aluminum foil layer 30 is processed by a chemical treatment to form a dense oxide film before laminating, thereby enhancing the barrier properties of moisture and oxygen of the aluminum foil. The chemical treatment can be, for example, a chemical treatment agent coated on the surface of the aluminum foil layer 30 and the coated aluminum foil baked at 80 to 180° C., thereby enhancing the number of polar functional groups on the surface of the aluminum foil layer 30.

In an embodiment of the present invention, the thickness of the aluminum foil layer 30 is between 15 and 60 When the thickness of the aluminum foil layer 30 is less than 15 cracks or pinholes are generated more likely on the aluminum foil layer 30 during deep drawing, and the gas barrier properties of the aluminum foil layer 30 are affected. When the thickness of the aluminum foil layer 30 is greater than 60 μm, the thickness and weight of the composite packaging material are increased.

The aluminum foil layer 30 and the heat seal layer 50 are adhered by the polyolefin adhesive layer 40. The polyolefin adhesive layer 40 is preferably a polyolefin adhesive containing at least one of polyethylene or polypropylene. The thickness of the polyolefin adhesive layer 40 can be between 2 and 10 μm to provide good adhesion and electrolyte resistance. In the composite packing material for the lithium battery packaging of the present invention, a well-known polyolefin adhesive suitable for this technical field can be used to adhere to the aluminum foil layer 30 and the heat seal layer 50 without any particular limitation.

The heat seal layer 50 of the composite packaging material for a lithium battery of the present invention may be such as, a polyolefin film, for good heat-sealability, electrolyte corrosion resistance, puncture resistance and insulation properties thereof. In an embodiment of the present invention, the heat seal layer 50 can be at least one selected from thermoplastic resin films such as polyethylene, polypropylene and olefin-based copolymer. In a preferred embodiment of the present invention, the heat seal layer 50 can be a polypropylene film. The thickness of the heat seal layer 50 can be between 30 and 80 μm to provide sufficient heat-sealability, good electrolyte resistance, and other properties required as battery packaging materials.

The present invention will be explained in further detail with reference to the examples. However, the present invention is not limited to these examples.

### Example 1

88.89 g of polyester polyol (TM-K55, available from Toyo Advanced Science, Taiwan) and 11.11 g polyisocyanate were thoroughly mixed, and then ethyl acetate was added appropriately to obtain the polyurethane adhesive solution with a solid content of 15%. 4 g of 1,3,5-tris(3,5-di-tri-butyl-4-hydroxybenzyl)-1,3,5-triazine-2,4,6-trione (Evernox 3114, available from Everspring Chemical, Taiwan) mixed with ethyl acetate to prepare a multifunctional hindered phenol solution with a solid content of 15%. Then the multifunctional hindered phenol solution was added to the polyurethane adhesive solution, after being thoroughly mixed, a polyurethane adhesive solution containing multifunctional hindered phenol was obtained.

Preparation of Polyolefin Adhesive

100 g of maleic-anhydride-modified polypropylene (XP11B, available from Mitsui Chemicals, Japan) and 5 g of polyisocyanate hardener (N3390, available from Covestro, Germany) were thoroughly mixed, and then methylcyclohexane was added appropriately to obtain the polyolefin adhesive solution with a solid content of 15%.

Preparation of Composite Packaging Materials

The aforementioned polyurethane adhesive solution containing multifunctional hindered phenol was coated with a thickness of 3 um on one surface of the chemically treated aluminum foil (model of aluminum foil was A8021-0, available from Dongil Aluminum, South Korea; surface treated by BenQ Materials, Taiwan) with a thickness of 40 and then the polyimide film (RX-F, available from KOHJIN Film and Chemicals, Japan) having a thickness of 25 μm was adhered to the coated surface of the aluminum foil, and dried at 85° C. for 1.5 minutes afterwards. Further, the aforementioned polyolefin adhesive was coated with a thickness of Sum on the other side of the aluminum foil, and then the cast polypropylene film (ET20, available from Okamoto Co., Japan) having a thickness of 40 μm was adhered to the coated surface of the aluminum foil, and dried at 120° C. for 1.5 minutes afterwards. Finally, the laminated film was left to cure for 7 days, a composite packaging material for a lithium battery was obtained.

### Example 2

The composite packaging material was prepared in the same manner as in Example 1, but the use amount of the multifunctional hindered phenol was changed to 7 g.

### Example 3

The composite packaging material was prepared in the same manner as in Example 1, but the use amount of the multifunctional hindered phenol was changed to 10 g.

### Comparative Example 1

The composite packaging material was prepared in the same manner as in Example 1, except that no multifunctional hindered phenol was added to the polyurethane adhesive layer.

### Comparative Example 2

The composite packaging material was prepared in the same manner as in Example 1, but the use amount of the multifunctional hindered phenol was changed to 12 g.

The specific properties of the obtained composite packaging materials were determined in accordance with the measurement described hereinafter. The results were shown in table 1.

Measurement of Damping Factor (Tan δ) of the Polyurethane Adhesive Layer

The polyurethane adhesives obtained in each of the examples and comparative examples were poured into a flat-bottom box covered with a release film, and heated in an oven at 80° C. until no solvent remained and formed an adhesive sheet with a thickness of about 2 mm. The adhesive sheet of each of the examples and comparative examples was cured and dried at 40° C. for 7 days.

The cured adhesive sheet of each of examples and comparative examples was cut into a sample of 30±2 mm×3±1 mm×2±0.5 mm, and the storage modulus (G′) and the loss modulus (G″) at 30° C. of the sample was measured in the single cantilever mode by a dynamic mechanical analyzer (Q800, available from TA Instruments, USA) with the heating rate of 2° C./min and the test frequency of 1 Hz. Then, the damping factor (tan δ) was calculated from the following formula 1.

G′/G″=tan δ (formula 1)

Measurement of Peeling Strength Between Polyamide Film and Aluminum Foil

The peeling strength was measured according to ASTM D-1876. T-peeling test is performed on a 15 mm wide specimen.

Measurement of the Formability

The formability of the composite packing materials can be determined through the deep drawing test. The composite packaging material was punched in different depths at a speed of 3000 μm/sec, and the forming area was 200×100 mm. The test was repeated 5 times at each forming depth, and the appearance of the deep drawn sample was visually-observed after punching to determine whether or not any damage was present. If no damage was visually observed on the sample, it was judged that the formability was pass.

TABLE 1

| | | | | Compar- | Compar- |
|---|---|---|---|---|---|
| | | | | ative | ative |
| | Example | Example | Example | Example | Example |
| | 1 | 2 | 3 | 1 | 2 |
| Storage | 15 | 16 | 24 | 26 | 17 |
| modulus | | | | | |
| G′ @ 30° C. | | | | | |
| (MPa) | | | | | |
| Loss modulu | 6.8 | 9.6 | 13.2 | 9.9 | 6.3 |
| G″ @ 30° C. | | | | | |
| (MPa) | | | | | |
| tanδ | 0.45 | 0.6 | 0.55 | 0.38 | 0.37 |
| Peeling | 3.67 | 3.92 | 3.71 | 3.82 | 3.07 |
| strangth | | | | | |
| (N/15 mm) | | | | | |
| Formability | 5 Pass/5 | 5 Pass/5 | 5 Pass/5 | 3 Pass/5 | 2 Pass/5 |
| (7.5 mm | | | | | |
| of depth) | | | | | |
| Formability | 5 Pass/5 | 5 Pass/5 | 5 Pass/5 | 0 Pass/5 | 0 Pass/5 |
| (8.0 mm | | | | | |
| of depth) | | | | | |
| Formability | 5 Pass/5 | 5 Pass/5 | 4 Pass/5 | N/A | N/A |
| (8.5 mm | | | | | |
| of depth) | | | | | |

Compared with the comparative examples, the formability of the composite packaging materials of Examples 1 to 3 were all enhanced by at least 1.0 mm of depth. The polyurethane adhesive layer of the present invention with a damping factor in a specific range could be a buffer and therefore, enhance the formability of the composite packaging materials during deep drawing. The peeling strength of Examples 1 to 3 was not adversely effected even the multifunctional hindered phenol was added into the polyurethane adhesive layer.

The multifunctional hindered phenol was added to the adhesive polyurethane layer of the composite packaging material of the present invention and hydrogen-bonded with the polyurethane to perform a good damping effect, which can effectively buffer and dissipate the stress applied to the composite packaging material during deep drawing, and the damage of the composite packaging material can be reduced. Therefore, the formability of the composite packaging material can be improved, and the other required characteristics thereof as a battery packaging film can still be maintained.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A composite packaging material for a lithium battery sequentially comprising:
a protective layer;
an adhesive polyurethane layer;
an aluminum foil layer;
an adhesive polyolefin layer; and
a heat seal layer;
wherein a damping factor of the adhesive polyurethane layer is in the range between 0.45 and 0.6.

2. The composite packaging material for a lithium battery as claimed in claim 1, wherein the adhesive polyurethane layer comprises a polyurethane adhesive and a multifunctional hindered phenol, wherein the amount of multifunctional hindered phenol is from 4 to 10 parts by weight relative to per hundred parts by weight of polyurethane adhesive.

3. The composite packaging material for a lithium battery as claimed in claim 2, wherein the multifunctional hindered phenol comprises at least one of trifunctional hindered phenol or tetrafunctional hindered phenol.

4. The composite packaging material for a lithium battery as claimed in claim 2, wherein the multifunctional hindered phenol is at least one selected from the group consisting of 1,3,5-tris(3,5-di-tert-butyl-4-hydroxybenzyl)-1,3,5-triazinane-2,4,6-trione, 1,3,5-trimethyl-2,4,6-tri-(3,5-di-tert-butyl-4-hydroxybenzyl)benzene, pentaerythritol tetrakis(3-(3,5-di-tert-butyl-4-hydroxyphenyl)propionate), and the combination thereof.

5. The composite packaging material for a lithium battery as claimed in claim 1, wherein the polyurethane adhesive comprises 85.7 to 90.9 parts by weight of polyester polyol and 10.1 to 14.3 parts by weight of polyisocyanate.

6. The composite packaging material for a lithium battery as claimed in claim 1, wherein the thickness of the adhesive polyurethane layer is in the range between 2 μm and 10 μm.

7. A composite packaging material for a lithium battery sequentially comprising:
a protective layer;
an adhesive polyurethane layer;
an aluminum foil layer;
an adhesive polyolefin layer; and
a heat seal layer;
wherein the adhesive polyurethane layer comprises a polyurethane adhesive and a multifunctional hindered phenol, and the amount of multifunctional hindered phenol is from 4 to 10 parts by weight relative to the hundred parts by weight of polyurethane adhesive.

8. The composite packaging material for a lithium battery as claimed in claim 7, wherein the multifunctional hindered phenol comprises at least one of trifunctional hindered phenol or tetrafunctional hindered phenol.

9. The composite packaging material for a lithium battery as claimed in claim 7, wherein the multifunctional hindered phenol is at least one selected from the group consisting of 1,3,5-tris(3,5-di-tert-butyl-4-hydroxybenzyl)-1,3,5-triazinane-2,4,6-trione, 1,3,5-trimethyl-2,4,6-tri-(3,5-di-tert-butyl-4-hydroxybenzyl)benzene, pentaerythritol tetrakis(3-(3,5-di-tert-butyl-4-hydroxyphenyl)propionate), and the combination thereof.

10. The composite packaging material for a lithium battery as claimed in claim 7, wherein the polyurethane adhesive comprises 85.7 to 90.9 parts by weight of polyester polyol and 10.1 to 14.3 parts by weight of polyisocyanate.

11. The composite packaging material for a lithium battery as claimed in claim 10, wherein a glass transition temperature (T_{g}) of the polyester polyol is in the range between −10° C. to 30° C.

12. The composite packaging material for a lithium battery as claimed in claim 10, wherein the polyester polyol is obtained by polymerizing a polyacid containing carboxyl group (COOH) and a polyol containing hydroxyl group (OH), and the number average molecular weight of the polyester polyol is between 8,000 and 30,000.

13. The composite packaging material for a lithium battery as claimed in claim 10, wherein the polyisocyanate is at least one selected from the group consisting of trimethylene diisocyanate, tetramethylene diisocyanate, hexamethylene diisocyanate, 1,2-propylene diisocyanate, 1,2-butene diisocyanate, 2,3-butene diisocyanate, 1,3-butene diisocyanate, 2,4,4-trimethylhexamethylene diisocyanate, 2,2,4-trimethylhexamethylene diisocyanate, 2,6-diisocyanate methylhexanoate diisocyanate, 1,4-cyclohexane diisocyanate, 1,3-cyclohexane diisocyanate, m-phenylene diisocyanate, p-phenylene diisocyanate, 4,4′-diphenyl diisocyanate, 1,5-naphthalene diisocyanate, 4,4′-diphenylmethane diisocyanate, 2,4-toluene diisocyanate, 2,6-toluene diisocyanate and the combination thereof, 4,4′-toluidine diisocyanate, 3,3′-dimethoxybenzidine diisocyanate, 4,4′-diphenyl ether diisocyanate, 1,3-xylene diisocyanate, 1,4-xylene diisocyanate and the combination thereof, ω,ω′-diisocyanate-1,4-diethylbenzene, 1,3-bis(1-isocyanato-1-methylethyl)benzene, 1,4-bis(1-isocyanato-1-methylethyl)benzene and the combination thereof, triphenylmethane-4,4′,4″-triisocyanate, benzene-1,3,5-triisocyanate, toluene-2,4,6-triisocyanate, 4,4′-diphenyldimethylmethane-2,2′,5,5′-tetraisocyanate, and dimer, trimer, biuret and urethanate derived from the above isocyanate monomer, and the polyisocyanate containing 2,4,6-oxadiazine trione ring derived from carbon dioxide and the above isocyanate monomer, and the combination thereof.

14. The composite packaging material for a lithium battery as claimed in claim 7, wherein a damping factor of the adhesive polyurethane layer is in the range between 0.45 and 0.6.
